(19) United States
(12) Patent Application Publication
(10) Pub. No.: US 2026/0203935 A1
(43) Pub. Date: Jul. 16, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventors: YOSHIKATSU NAKAJIMA, TOKYO (JP); SHUNICHI HOMMA, TOKYO (JP); ANDREAS KONSTANTIN KUHN, TOKYO (JP); TAKAAKI KATO, TOKYO (JP); MANABU KAWASHIMA, TOKYO (JP)

(21) Appl. No.: 19/135,653

(22) PCT Filed: Oct. 25, 2023
(86) PCT No.: PCT/JP2023/038553

§ 371 Date: Jun. 4, 2025

(30) Foreign Application Priority Data
Dec. 12, 2022 (JP) 2022-198095

(51) Int. Cl. G06T 7/73; G06T 7/579

(52) U.S. Cl. CPC G06T 7/74; G06T 7/579

(57) ABSTRACT

There is provided a technique capable of reducing a processing load while maintaining accuracy in estimating a three-dimensional structure based on SfM technology.

There is provided an information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

### TECHNICAL FIELD

The present disclosure relates to an information processing device, an information processing method, and a program.

### BACKGROUND ART

As a technique of estimating a three-dimensional structure of a predetermined space from a plurality of two-dimensional images obtained by imaging the space, a technique called Structure from Motion (SEM) has been known. In addition, in a process of estimating the three-dimensional structure based on the SfM technology, various methods for reducing the processing load of computation have been studied. For example, Non-Patent Document 1 discloses a technique of reducing a calculation amount in a calculation process of estimating a position of a three-dimensional point indicating the three-dimensional structure.

### CITATION LIST

### Non-Patent Document

Non-Patent Document 1: Kurt Konolige, “Sparse Sparse Bundle Adjustment”, September 2010, [Online], [Searched on Nov. 29, 2022], Internet <http://www.bmva.org/bmvc/2010/conference/paper102/paper1 02.pdf>

### SUMMARY OF THE INVENTION

### Problems to be Solved by the Invention

In the SfM technology as described above, it is known that the memory consumption of a computing part of correction processing of an estimated three-dimensional position or the like is high and is a computational bottleneck.

### Solutions to Problems

In order to solve the problem described above, according to an aspect of the present disclosure, there is provided an information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

Furthermore, according to the present disclosure, there is provided an information processing method to be executed by a computer, the method causing a processor to execute correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

Furthermore, according to the present disclosure, there is provided a program that causes a computer to function as an information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

### BRIEF DESCRIPTION OF DRAWINGS

FIG. 1 is an explanatory diagram illustrating an application example of an information processing system according to an embodiment of the present disclosure.

FIG. 2 is an explanatory diagram illustrating a general processing flow of a process of estimating a three-dimensional structure using SfM technology.

FIG. 3 is an explanatory diagram for explaining correction processing based on the SfM technology.

FIG. 4 is a diagram for explaining a processing target of existing correction processing based on the SEM technology.

FIG. 5 is an explanatory diagram illustrating a processing flow of a process of estimating a three-dimensional structure by an information processing device 20 according to the present embodiment.

FIG. 6 is a diagram for explaining selection of a processing target by the information processing device 20 according to the present embodiment.

FIG. 7 is a block diagram illustrating an exemplary configuration of an imaging device 10 according to the present embodiment.

FIG. 8 is a block diagram illustrating an exemplary configuration of the information processing device 20 according to the present embodiment.

FIG. 9 is a diagram for explaining matching processing by a matching unit 233 according to the present embodiment.

FIG. 10 is a diagram for explaining position estimation processing by an optimization unit 237.

FIG. 11 is a diagram for explaining correction processing by the optimization unit 237 according to the present embodiment.

FIG. 12 is a diagram for explaining a first method of selecting a processing target by the selection unit 235 according to the present embodiment.

FIG. 13 is a diagram for explaining a second method of selecting the processing target by the selection unit 235 according to the present embodiment. 10

FIG. 14 is an explanatory diagram illustrating an example of attribute information associated with a feature point F according to the present embodiment.

FIG. 15 is a diagram for explaining a third method of selecting the processing target by the selection unit 235 according to the present embodiment.

FIG. 16 is a diagram for explaining a fourth method of selecting the processing target by the selection unit 235 according to the present embodiment.

FIG. 17 is a diagram for explaining a variation of the fourth method of selecting the processing target by the selection unit 235 according to the present embodiment.

FIG. 18 is a flowchart for explaining exemplary operation of the information processing system according to the present embodiment.

FIG. 19 is a flowchart for explaining an exemplary flow of a process of selecting the processing target by the selection unit 235 according to the present embodiment.

FIG. 20 is a block diagram illustrating a hardware configuration 90 according to an embodiment of the present disclosure.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference signs, and redundant description will be omitted.

In addition, in the present specification and drawings, a plurality of components having substantially the same functional configuration may be distinguished from each other with different alphabets or numbers attached after the same reference sign. However, in a case where each of the plurality of components having substantially the same functional configuration does not need to be particularly distinguished from each other, each of the plurality of components is denoted by only the same reference sign.

Note that the description will be given in the following order.
1. Outline
1-1. Exemplary system configuration
1-2. Review of problems
2. Exemplary functional configuration
2-1. Imaging device 10
2-2. Information processing device 20
3. Detailed processing of selection unit
3-1. First selection method
3-2. Second selection method
3-3. Third selection method
3-4. Fourth selection method
3-5. Supplement
4. Exemplary operation
5. Exemplary hardware configuration
6. Conclusion

### 1. Outline

First, an outline of an embodiment of the present disclosure will be described. An information processing system according to the present disclosure relates to an information processing device that generates, using SEM technology, a three-dimensional point group representing a predetermined space on the basis of a plurality of two-dimensional images obtained by imaging the space.

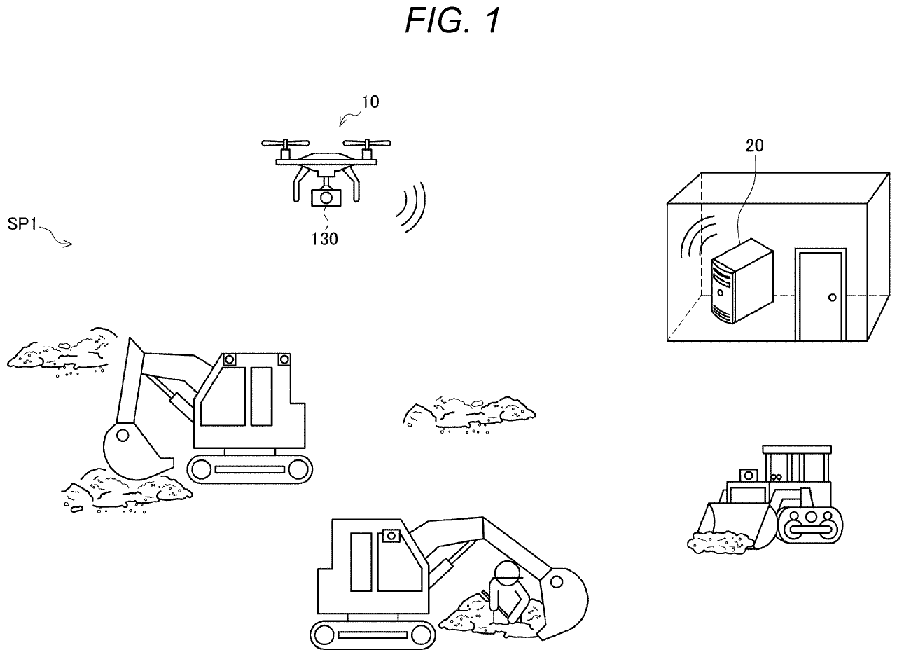

FIG. 1 is an explanatory diagram illustrating an application example of the information processing system according to an embodiment of the present disclosure.

FIG. 1 illustrates an example in which an information processing device 20 generates a three-dimensional point group representing topographic features of a space SP1, which is a construction site. In the example illustrated in FIG. 1, the information processing device 20 receives, from an imaging device 10, a plurality of images obtained by imaging the space SP1 from above, and generates a three-dimensional point group of the topographic features of the space SP1 on the basis of the plurality of received images. The generated three-dimensional point group may be utilized at, for example, a construction site, a building site, or the like.

Note that the application destination of the present information processing system illustrated in FIG. 1 is merely an example, and the preferred application destination of the present information processing system is not limited to such an example.

For example, the three-dimensional structure to be restored by the present information processing system is not particularly limited, and is not limited to topographic features of a construction site or building site, or the like. For example, the present information processing system is also applicable to an example of estimating a three-dimensional structure of a subject captured using a camera of a smartphone, and the like.

### 1-1. Exemplary System Configuration

As illustrated in FIG. 1, the information processing system according to the embodiment of the present disclosure includes the imaging device 10 and the information processing device 20.

The imaging device 10 and the information processing device 20 are communicably connected to each other via a network.

### (Imaging Device 10)

The imaging device 10 according to the present embodiment has a function of imaging a predetermined space.

The imaging device 10 images a subject (predetermined space) as a target for restoring a three-dimensional structure at various different imaging positions and imaging postures.

In the example illustrated in FIG. 1, the imaging device 10 is a drone that holds a camera 130 and images the space SP1 from above. In this case, the imaging device 10 may image the space SP1 from various imaging positions while moving above the space SP1.

Furthermore, in a case where the imaging device 10 is implemented by a drone, the imaging device 10 may image the space SP1 to include a control point (ground control point, check point) set on the ground in the space SP1.

Note that the imaging device 10 according to the present embodiment may be implemented by another device including a camera capable of imaging the predetermined space. For example, the imaging device 10 is not limited to a mobile body such as a drone. The imaging device 10 may be implemented by, for example, a smartphone, a tablet terminal, a game machine, or the like.

Furthermore, while FIG. 1 illustrates an exemplary case where the information processing system according to the present embodiment includes one imaging device 10, the number of the imaging devices 10 according to the present embodiment is not particularly limited. For example, the information processing system according to the present embodiment may include two or more imaging devices 10.

The imaging device 10 transmits a plurality of images obtained by imaging the space SP1 to the information processing device 20.

### (Information Processing Device 20)

The information processing device 20 according to the present embodiment obtains, from the imaging device 10, the plurality of images obtained by imaging the space SP1.

The information processing device 20 according to the present embodiment estimates a three-dimensional structure of the space SP1 on the basis of the plurality of obtained images using the SfM technology, and generates a three-dimensional point group representing the three-dimensional structure.

In the example illustrated in FIG. 1, the information processing device 20 receives, from the imaging device 10, the plurality of images obtained by imaging the space SP1 from above, and generates a three-dimensional point group of the topographic features of the space SP1 on the basis of the plurality of received images.

As described above, the technique of restoring a shape of a subject (space SP1 in the example of FIG. 1) included in a plurality of images captured at different imaging positions and imaging postures is referred to as the SfM technology.

### 1-2. Review of Problems

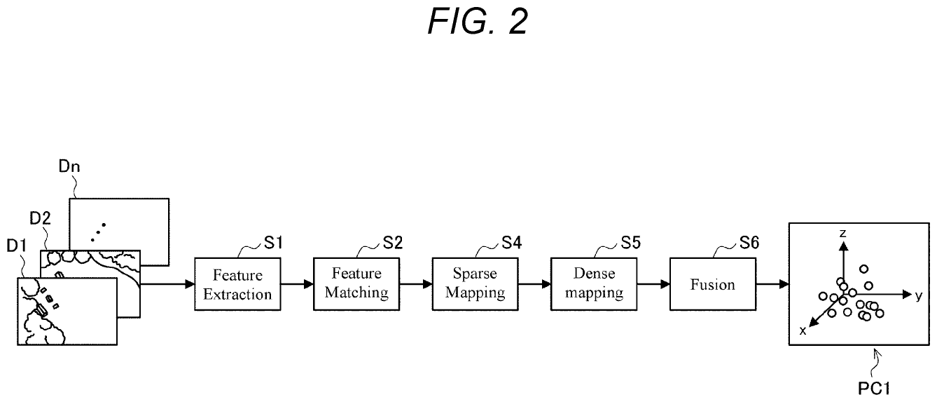

Here, a flow of the process of estimating the three-dimensional structure from the plurality of two-dimensional images using the SfM technology will be described with reference to FIGS. 2 to 4.

FIG. 2 is an explanatory diagram illustrating a general processing flow of the process of estimating the three-dimensional structure using the SfM technology. An image D indicates each of images of a predetermined space captured by a sensor of a camera or the like.

Each of the images D is desirably an image obtained by imaging a subject, which is a target for restoring a three-dimensional structure, from various different imaging positions.

As illustrated in FIG. 2, first, feature points are extracted from each of the images D (S1: Feature Extraction).

Next, among the extracted feature points, corresponding feature points are matched among the plurality of images D (S2: Feature Matching).

Next, an imaging position and an imaging posture of each image and a three-dimensional position indicating a position of a feature point in the three-dimensional space are estimated on the basis of the feature points that correspond to each other among the plurality of images. At this time, position estimation processing and correction processing (also referred to as optimization processing) of errors in a result of the estimation of the imaging position, imaging posture, and three-dimensional position are simultaneously performed. As a result, a sparse three-dimensional point group, which indicates the three-dimensional positions of the corresponding feature points among the plurality of images, is obtained (S4: Sparse Mapping).

Next, processing of generating a denser (dense) three-dimensional point group is performed on the basis of the sparse three-dimensional point group generated in S4 (S5: Dense Mapping).

Next, a three-dimensional point group representing a final estimation result of the three-dimensional structure is generated on the basis of the two-dimensional positions and the three-dimensional positions of the corresponding feature points among the plurality of images D after the correction. (S6: Fusion).

According to the series of processing described above, a three-dimensional point group PC in which the predetermined space is represented by the point group is output.

In the processing pipeline as described above, it is conventionally known that the memory consumption of the computing part of the correction processing in S4 is high and is a computational bottleneck.

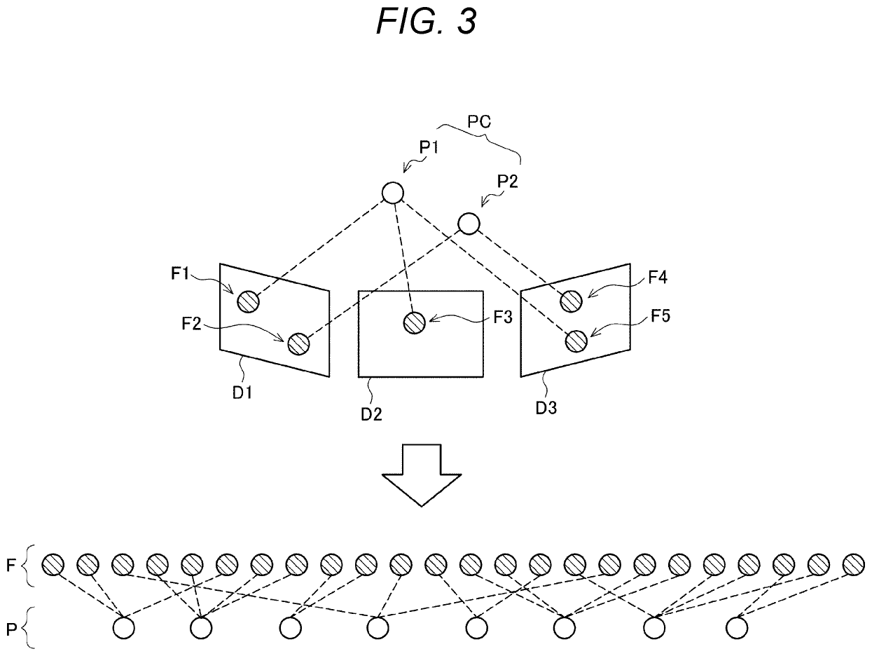

More detailed descriptions will be given with reference to FIG. 3. FIG. 3 is an explanatory diagram for explaining the correction processing based on the SEM technology.

A feature point F illustrated in FIG. 3 represents a feature point extracted from each of the plurality of images D.

In addition, a three-dimensional point P represents a three-dimensional position of the feature point F calculated on the basis of the corresponding feature point F among the plurality of images D.

According to the SfM technology, a three-dimensional position of the three-dimensional point P corresponding to the feature point F is estimated on the basis of the two-dimensional position of the corresponding feature point F (position of the feature point F on the image) extracted from each of the images D captured from different positions and the imaging position of each of the images D.

As the imaging position of each of the images D, position information of the imaging device 10 that has captured the image D may be given together with the image D as input data. Alternatively, in a case where the imaging position of each of the images D is not given as input data, the imaging position of each of the images D may be estimated on the basis of the two-dimensional position of the corresponding feature point F among the plurality of images D.

In the example illustrated in FIG. 3, the feature points F connected to the same three-dimensional point P by broken lines indicate the feature points that correspond to each other among the plurality of images D. For example, a feature point F1, a feature point F3, and a feature point F5 indicate the feature points that correspond to each other among images D1 to D3. In addition, a three-dimensional point P1 indicates a three-dimensional position estimated on the basis of the corresponding feature point F1, feature point F3, and feature point F5.

Likewise, the three-dimensional position of the three-dimensional point P is estimated for each set of the plurality of corresponding feature points F.

The imaging position of each of the images D or the two-dimensional position of each of the feature points F, which is used to estimate the three-dimensional position of the three-dimensional point P as described above, may include an error due to various factors such as noise. Thus, in order to remove such an error, the correction processing (optimization processing) of each estimated position is performed.

For example, the three-dimensional position of the three-dimensional point P, the two-dimensional position of the feature point F, or the imaging position of the image D is corrected such that a straight line connecting the three-dimensional point P and the imaging position of the image D from which the one feature point F corresponding to the three-dimensional point P is extracted intersects at the two-dimensional position of the one feature point F. Such correction processing is referred to as bundle adjustment.

According to the SfM technology, conventionally, the position estimation processing and the correction processing as described above are collectively performed on the entire corresponding feature points F among the plurality of images extracted from the plurality of input images D.

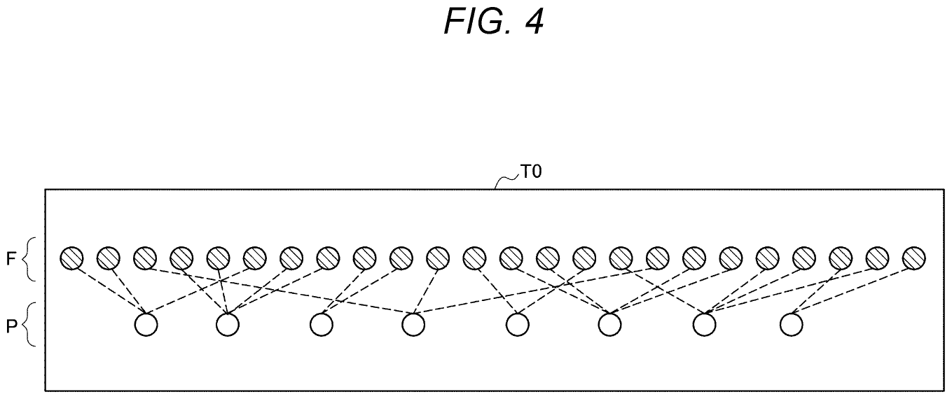

FIG. 4 is a diagram for explaining a processing target of the existing correction processing based on the SfM technology. It is assumed that the feature points F illustrated in FIG. 4 are the entire corresponding feature points F extracted from the plurality of input images D. According to the existing method, as indicated by a processing target TO, the correction processing is collectively performed on the entire feature points F with respect to the two-dimensional positions of the feature points F and the three-dimensional points P corresponding to the feature points F.

Thus, as the number of pieces of the input images D increases, the memory consumption in the calculation of the correction processing increases.

For example, according to the sparse bundle adjustment (SBA) technique disclosed in Non-Patent Document 1, the correction processing described above is handled as a non-linear optimization problem that obtains, as a solution, a parameter that minimizes an error between a two-dimensional position to be corrected and a reprojection point of a three-dimensional position on an image. The parameter includes an imaging position and imaging posture of an image, a two-dimensional position of a feature point, and a three-dimensional position. In this case, a calculation process is repeatedly performed in which a linear partial problem centered on the current solution is formed, the linear partial problem is solved, and the processing is repeated until the solution converges. At this time, the calculation amount of the linear partial problem increases as the cube of the number of cameras.

As described above, the calculation amount of the correction processing in the SfM technology increases as the number of images of the input data increases. Therefore, in the process of estimating the three-dimensional structure using the SfM technology, the calculation amount of the correction processing is a computational bottleneck. Accordingly, for example, in an information processing device having limited computational resources, such as a smartphone, there has been a case where the correction processing as described above cannot be performed.

In view of the above, as a technique of reducing the memory consumption in the computation of the correction processing, a method of limiting information (e.g., number of extracted feature points) obtained from the input image D is conceivable. However, in this case, the accuracy in estimating the three-dimensional structure decreases at the cost of reduction in the memory consumption.

A technical idea according to an embodiment of the present disclosure has been conceived by focusing on the points as described above, and achieves reduction of a processing load while maintaining accuracy in estimating a three-dimensional structure based on SfM technology.

For this purpose, the information processing device according to the embodiment of the present disclosure executes correction processing for correcting two-dimensional position information of a feature point extracted from a plurality of images and three-dimensional position information corresponding to the feature point in a plurality of execution times for each data selected as a processing target of each time.

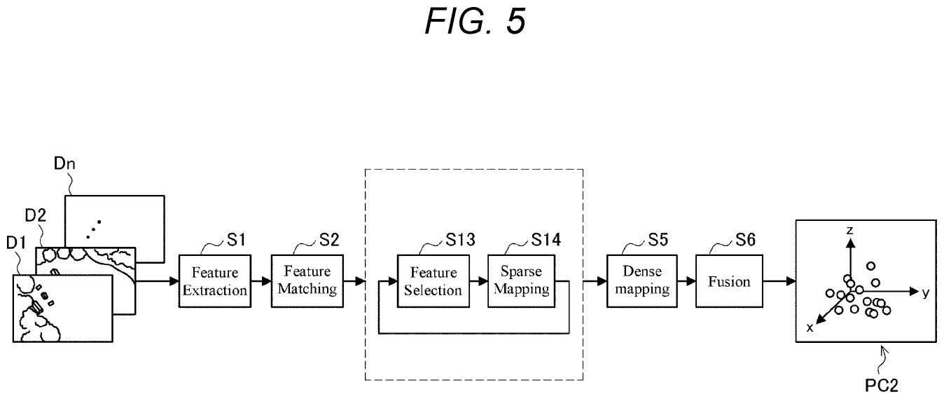

FIG. 5 is an explanatory diagram illustrating a processing flow of the process of estimating the three-dimensional structure by the information processing device 20 according to the present embodiment. S1, S2, S5, and S6 illustrated in FIG. 5 are similar to the processing described above with reference to FIG. 2, and thus redundant descriptions will be omitted.

As illustrated in FIG. 5, the information processing device 20 according to the present embodiment selects a feature point F to be processed at each time of the correction processing from among the corresponding feature points F among the plurality of images D obtained by the matching processing in S2 (S13: Feature Selection).

The information processing device 20 executes the correction processing on the two-dimensional position of the feature point F selected as the processing target of the correction processing in S13 and the three-dimensional position of the three-dimensional point P corresponding to the feature point F as the processing target (S14: Sparse Mapping).

Furthermore, in S14, the information processing device 20 according to the present embodiment may correct imaging position information, which indicates the imaging position of the image from which the feature point F selected as the processing target has been extracted, and posture information, which indicates the imaging posture.

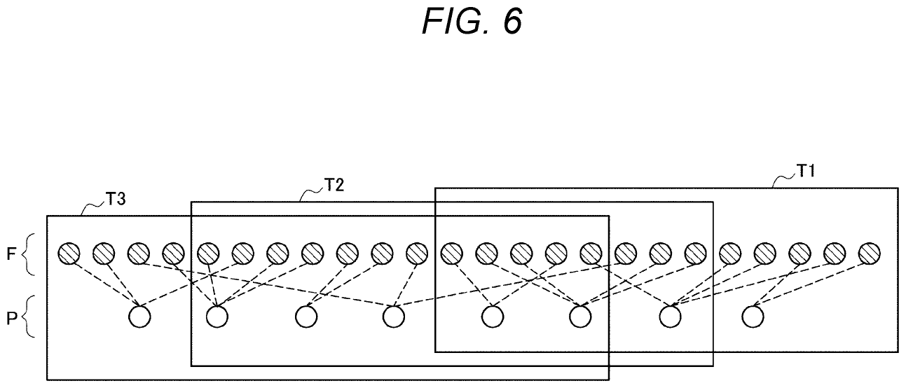

FIG. 6 is a diagram for explaining selection of the processing target by the information processing device 20 according to the present embodiment. As illustrated in FIG. 6, the information processing device 20 according to the present embodiment selects some of the corresponding feature points F among the plurality of extracted images as processing targets of the correction processing of each time.

In the example illustrated in FIG. 6, the information processing device 20 selects a processing target T1 as a processing target of the first execution of the correction processing.

Furthermore, in the example illustrated in FIG. 6, the information processing device 20 selects a processing target T2 as a processing target of the second execution of the correction processing. Moreover, the information processing device 20 selects a processing target T3 as a processing target of the third execution of the correction processing.

In this manner, the information processing device according to the present embodiment selects the processing target such that the correction processing for the entire corresponding feature points F among the plurality of extracted images is performed in a plurality of times.

Note that, while FIG. 6 illustrates an exemplary case where the correction processing for the entire corresponding feature points F among the plurality of images is performed three execution times in total, the total number of times of execution and the number of processing targets in each execution time are not limited thereto.

Furthermore, the feature points F to be processed in each execution time of the correction processing may be selected to overlap between different execution times, or may be selected not to overlap.

Assuming that the selection processing in S13 and the optimization processing in S14 by the information processing device 20 are one iteration, the information processing device 20 selects the processing target of each execution time such that the correction processing is progressively performed on the entire corresponding feature points F among the plurality of images throughout all iterations.

With the process as described above being performed, the processing load of the computation of the correction processing in each execution time is reduced.

Furthermore, as described above, the information processing device 20 according to the present embodiment performs the correction processing without reducing the total number of feature points to be subjected to the correction processing among the feature points extracted from the image D. Thus, the processing load may be reduced while maintaining the accuracy in estimating the three-dimensional structure.

Moreover, the information processing device 20 according to the embodiment of the present disclosure may select data to be processed at each execution time of the correction processing on the basis of reliability information indicating the reliability of each of the feature points F.

Furthermore, the information processing device 20 according to the embodiment of the present disclosure may select the data to be processed at each execution time of the correction processing such that a feature point F having higher reliability among the individual feature points F is included in the processing target in the execution time of the initial stage among the plurality of execution times of the correction processing.

For example, the information processing device 20 according to the present embodiment may use, as the reliability information, information indicating a feature point or an image D having higher robustness in the SEM technology, such as information regarding the feature point (e.g., resolution, imaging position information, other attribute information, etc. of the image D). The reliability information will be described in more detail later.

With the process as described above being performed, the three-dimensional position of the three-dimensional point group indicating the space SP1 may be highly accurately estimated at the initial stage of the correction processing.

Furthermore, the information processing device 20 according to the embodiment of the present disclosure may select data to be processed at each execution time on the basis of one or both of a setting value of the number of pieces of data to be processed at each execution time of the correction processing and a setting value of the total number of times of execution indicating how many times the correction processing is to be executed separately.

Alternatively, the information processing device 20 according to the embodiment of the present disclosure may select data to be processed at each execution time of the correction processing by comparing the reliability of each of the feature points F with a predetermined threshold.

With the process as described above being performed, the processing load at each execution time of the correction processing may be reduced depending on the calculation amount that may be processed by the computational resources of the information processing device 20.

Moreover, the information processing device 20 according to the embodiment of the present disclosure may dynamically set the setting value of the number of pieces of data to be processed at each execution time of the correction processing or the setting value of the total number of times of execution depending on processing load conditions of the information processing device 20.

With this arrangement, the processing load at each execution time of the correction processing may be dynamically reduced depending on usage conditions of the computational resources included in the information processing device 20.

With the process as described above being performed by the information processing device 20, the information processing device 20 is enabled to execute the process of estimating the three-dimensional structure from the plurality of two-dimensional images even in a case where computing power of the information processing device 20 is limited.

Hereinafter, exemplary functional configurations of the imaging device 10 and information processing device included in the present information processing system that implements the descriptions above will be described in detail.

### 2. Exemplary Functional Configuration

### 2-1. Exemplary Configuration of Imaging Device 10

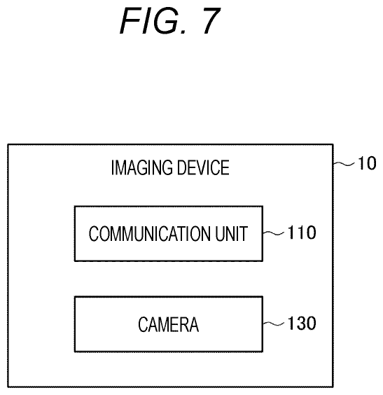

FIG. 7 is a block diagram illustrating an exemplary configuration of the imaging device 10 according to the present embodiment.

As illustrated in FIG. 7, the imaging device 10 according to the present embodiment may include a communication unit 110 and the camera 130.

### (Communication Unit 110)

The communication unit 110 according to the present embodiment has a function of communicating with another device.

For example, the communication unit 110 communicates with the information processing device 20. The communication unit 110 transmits, to the information processing device 20, the image D of the space SP1 obtained by the camera 130.

### (Camera 130)

The camera 130 according to the present embodiment has a function of imaging the space SP1.

The exemplary configuration of the imaging device according to the present embodiment has been described above. Note that the configuration described above with reference to FIG. 7 is merely an example, and the configuration of the imaging device 10 according to the present embodiment is not limited to such an example.

For example, the camera 130 according to the present embodiment may further include a position measurement unit not illustrated in FIG. 7.

The position measurement unit may obtain position information of the imaging device 10. For example, the position measurement unit may receive a global navigation satellite system (GNSS) signal, and may measure the latitude, longitude, and altitude of the imaging device 10.

The communication unit 110 may transmit, to the information processing device 20, the position information of the imaging device 10 obtained by the position measurement unit as imaging position information of the image D captured by the camera 130.

Furthermore, the imaging device 10 according to the present embodiment may further include a posture measuring unit (not illustrated). The posture measuring unit may be implemented by, for example, an inertial measurement unit (IMU) capable of obtaining acceleration and angular velocity of the imaging device 10.

The communication unit 110 may transmit, to the information processing device 20, the posture information of the imaging device 10 obtained by the posture measuring unit as information indicating the imaging posture of the image D captured by the camera 130.

Furthermore, the imaging device 10 may include a range sensor not illustrated in FIG. 7.

The range sensor may obtain depth information of a ranging point by measuring a distance between the imaging device 10 and a subject included in a range captured by the camera 130.

The communication unit 110 may associate the depth information obtained by the range sensor with an image area on the image D obtained by the camera 130, and may transmit it to the information processing device 20.

Furthermore, the imaging device 10 according to the present embodiment may further include, for example, an input unit that receives an input of information made by a user, a display unit that displays various types of information, and the like.

The configuration of the imaging device 10 according to the present embodiment may be flexibly modified according to specifications and operations.

### 2-2. Exemplary Configuration of Information Processing Device 20

Next, an exemplary configuration of the information processing device 20 according to the present embodiment will be described in detail.

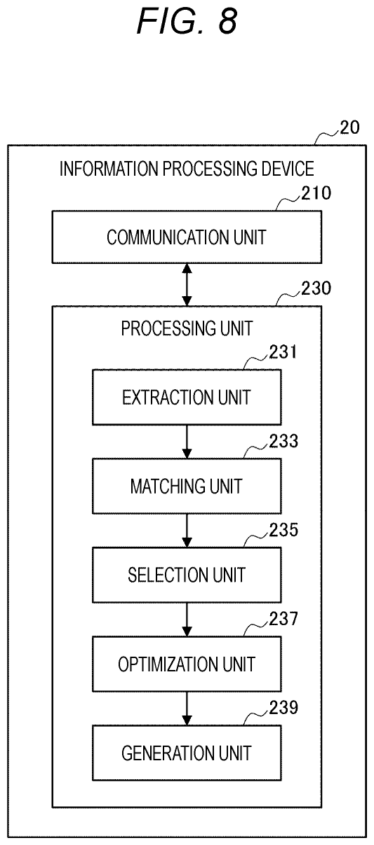

FIG. 8 is a block diagram illustrating an exemplary configuration of the information processing device 20 according to the present embodiment.

As illustrated in FIG. 8, the information processing device 20 according to the present embodiment may include a communication unit 210 and a processing unit 230.

### (Communication Unit 210)

The communication unit 210 according to the present embodiment has a function of communicating with another device.

For example, the communication unit 210 communicates with the imaging device 10. The communication unit 210 receives, from the imaging device 10, a plurality of images obtained by imaging the space SP1.

Furthermore, the communication unit 210 may obtain, from the imaging device 10, various types of information regarding the images.

For example, the communication unit 210 may obtain, from the imaging device 10, imaging position information indicating imaging positions of the images and posture information indicating imaging postures.

Furthermore, the communication unit 210 may obtain, from the imaging device 10, reliability information indicating the reliability of each of the images.

### (Processing Unit 230)

The processing unit 230 according to the present embodiment has a function of controlling the overall operation of the information processing device 20. Such a processing unit 230 has functions as an extraction unit 231, a matching unit 233, a selection unit 235, an optimization unit 237, and a generation unit 239.

### (Extraction Unit 231)

The extraction unit 231 extracts a feature point from each of the plurality of images obtained from the imaging device 10.

For example, the extraction unit 231 may extract, from each of the plurality of images, image local features such as a feature of scaled invariance feature transform (SIFT), a feature of speeded-up robust features (SURF), and the like. Alternatively, the extraction unit 231 may extract another feature from each of the plurality of images.

### (Matching Unit 233)

The matching unit 233 performs matching processing on the feature points extracted by the extraction unit 231 among the plurality of images.

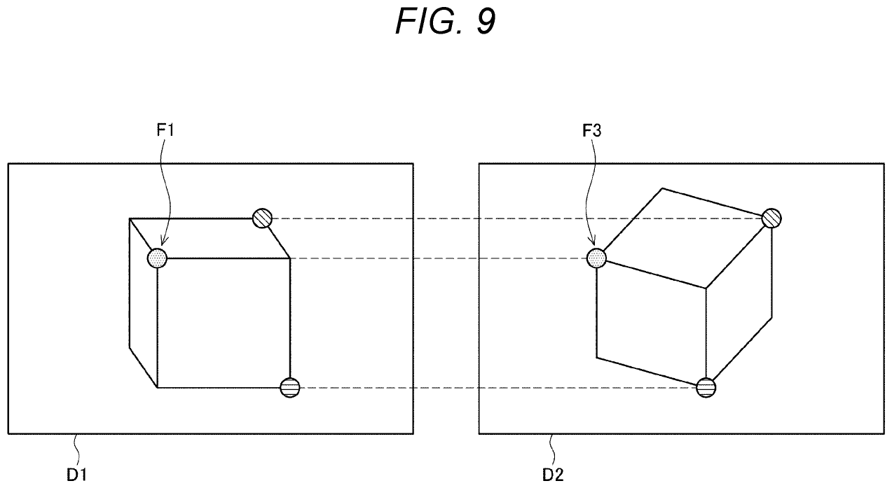

FIG. 9 is a diagram for explaining the matching processing by the matching unit 233 according to the present embodiment.

An image D1 and an image D2 illustrated in FIG. 9 represent images obtained by the information processing device 20 from the imaging device 10. A feature point F1 represents a feature point extracted by the extraction unit 231 from the image D1. A feature point F3 represents a feature point extracted from the image D2.

In the example illustrated in FIG. 9, the image D1 and the image D2 are images obtained by imaging the same cube from different imaging positions and imaging postures. Furthermore, the feature point F1 and the feature point F3 are assumed to be feature points corresponding to the same vertex of the cube.

The matching unit 233 matches the feature points extracted by the extraction unit 231.

For example, the matching unit 233 calculates similarity among the feature points extracted by the extraction unit 231, thereby searching for corresponding feature points among the plurality of images D.

In the example illustrated in FIG. 9, the matching unit 233 detects the feature point F1 and the feature point F3 as the corresponding feature points between the images D1 and D2.

The matching unit 233 outputs the corresponding feature points among the plurality of images D on the basis of the matching result.

The selection unit 235 selects a feature point to be subjected to the correction processing by the optimization unit 237 to be described later from among the corresponding feature points among the plurality of images D output from the matching unit 233. The selection of the processing target by the selection unit 235 will be described in detail later.

The optimization unit 237 performs the position estimation processing of estimating the three-dimensional position of the three-dimensional point P corresponding to the feature points on the basis of the corresponding feature points among the plurality of images D output from the matching unit 233.

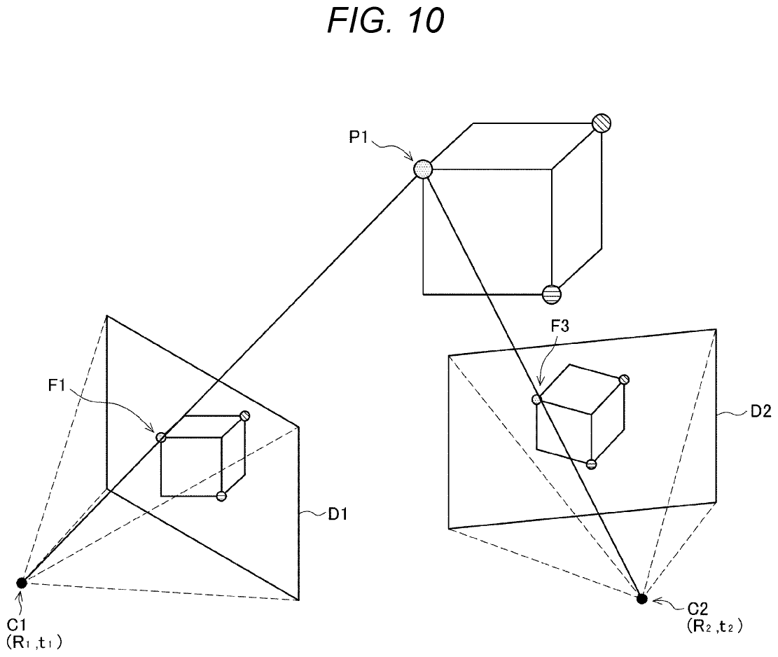

FIG. 10 is a diagram for explaining the position estimation processing by the optimization unit 237. The image D1, the image D2, the feature point F1, and the feature point F3 illustrated in FIG. 10 are as described with reference to FIG. 9, and thus redundant descriptions will be omitted.

A camera position C illustrated in FIG. 10 indicates an imaging position and an imaging posture of each of the images D. The camera position C may be represented by a translation vector t and a rotation matrix R for transforming a camera coordinate system in the camera 130 that has captured each of the images D into a three-dimensional orthogonal coordinate system in the three-dimensional point group representing the space SP1 as a point group.

The optimization unit 237 may estimate a camera position C1 and a camera position C2 of each of the images D1 and D2 on the basis of the feature point F1 and the feature point F3, which are the corresponding feature points between the images D.

Alternatively, the optimization unit 237 may calculate the camera position C of each of the images D using the imaging position information and posture information of each of the images D obtained by the position measurement unit of the imaging device 10.

Moreover, the optimization unit 237 performs the correction processing of correcting the two-dimensional position information indicating the positions of the corresponding feature points on the images D among the plurality of images D and the three-dimensional position information indicating the three-dimensional position of the estimated three-dimensional point P.

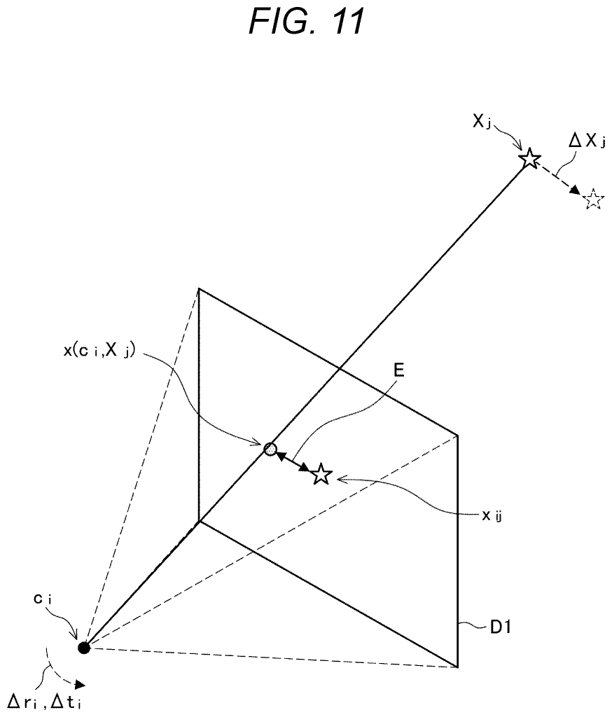

FIG. 11 is a diagram for explaining the correction processing by the optimization unit 237 according to the present embodiment.

In FIG. 11, xᵢⱼ represents a two-dimensional position of the feature point F extracted from the image D1 on the image D1.

In addition, Xⱼ represents an estimated three-dimensional position of the three-dimensional point P corresponding to xᵢⱼ.

The camera position C of the image D1 from which xᵢⱼ is extracted is represented by cᵢ.

Here, a line (bundle) connecting the three-dimensional position Xⱼ of the three-dimensional point P calculated by the optimization unit 237 performing the position estimation processing using the corresponding feature points F among the plurality of images D and the camera position cᵢ of the image D from which the feature point F is extracted should intersect at the two-dimensional position xᵢⱼ of the feature point.

Such a two-dimensional position on the image D1 positioned on the line connecting Xⱼ and cᵢ is defined as a reprojection point x(cᵢ, Xⱼ). At this time, an error between the two-dimensional point xᵢⱼ of one feature point F and the reprojection point x(cᵢ, Xⱼ) of the feature point F is defined as in the following equation (1).

$$\begin{matrix}[ Math . 1 ] & \\ {e}_{ij} = x ( {c}_{i} , {x}_{j} ) - {x}_{ij} & ( 1 )\end{matrix}$$

When the equation (1) mentioned above is used, the total error E between the reprojection point and the two-dimensional position of the feature point F for the entire corresponding feature points among the plurality of images D is expressed by the following equation (2).

$$\begin{matrix}[ Math . 2 ] & \\ E = \frac{1}{2} {\sum }_{i} {\sum }_{j} {e}_{ij} {Te}_{ij} & ( 2 )\end{matrix}$$

The optimization unit 237 may correct the three-dimensional position Xⱼ of the three-dimensional point P and the two-dimensional point Xᵢⱼ of the feature point F such that the total error E is minimized.

The optimization unit 237 according to the present embodiment separately performs the correction processing as described above on the entire corresponding feature points F output from the matching unit 233 for each feature point F selected as a processing target of each time by the selection unit 235 for a plurality of execution times.

At this time, the optimization unit 237 may correct the camera position C of the image D from which the feature point F has been extracted together with the two-dimensional position information of the feature point F and the three-dimensional position information of the three-dimensional point P corresponding to the feature point F.

The generation unit 239 performs processing of generating a three-dimensional point group in which the space SP1 is represented by a point group on the basis of the three-dimensional position information of the three-dimensional point P having been subject to the correction processing by the optimization unit 237.

The exemplary configuration of the information processing device 20 according to the present embodiment has been described above. Note that the configuration described above with reference to FIG. 8 is merely an example, and the configuration of the information processing device 20 according to the present embodiment is not limited to such an example.

For example, the information processing device 20 according to the present embodiment may further include an input unit that receives an input of information made by the user, a display unit that displays various types of information, and the like.

The configuration of the information processing device 20 according to the present embodiment may be flexibly modified according to specifications and operations.

### 3. Detailed Processing of Selection Unit

Next, a method of selecting a processing target of the correction processing by the selection unit 235 of the information processing device 20 will be described in detail.

As described above, the selection unit 235 of the information processing device 20 according to the present embodiment has a function of selecting data to be processed at each execution time with respect to the correction processing by the optimization unit 237.

More specifically, the optimization unit 237 selects a feature point F to be processed at each execution time of the correction processing from among the corresponding feature points F among the plurality of images D output as a result of the matching processing by the matching unit 233.

The optimization unit 237 performs the correction processing on the two-dimensional position information of the feature point F selected by the selection unit 235 as a processing target and the three-dimensional position information of the three-dimensional point P corresponding to the feature point F.

Moreover, the optimization unit 237 may correct the imaging position and imaging posture of the image D from which the feature point F is extracted together with the two-dimensional position information and three-dimensional position information corresponding to the feature point F.

With this arrangement, the processing load of the computation per execution of the correction processing is reduced as compared with a case where the correction processing by the optimization unit 237 is collectively performed on the entire feature points F output from the matching unit 233.

Furthermore, the selection unit 235 according to the present embodiment may select data to be processed at each execution time of the correction processing on the basis of the reliability information indicating the reliability of each of the feature points F.

Here, as the reliability information used by the selection unit 235 and a method of selecting a processing target at each execution time using the reliability information, several methods are conceivable.

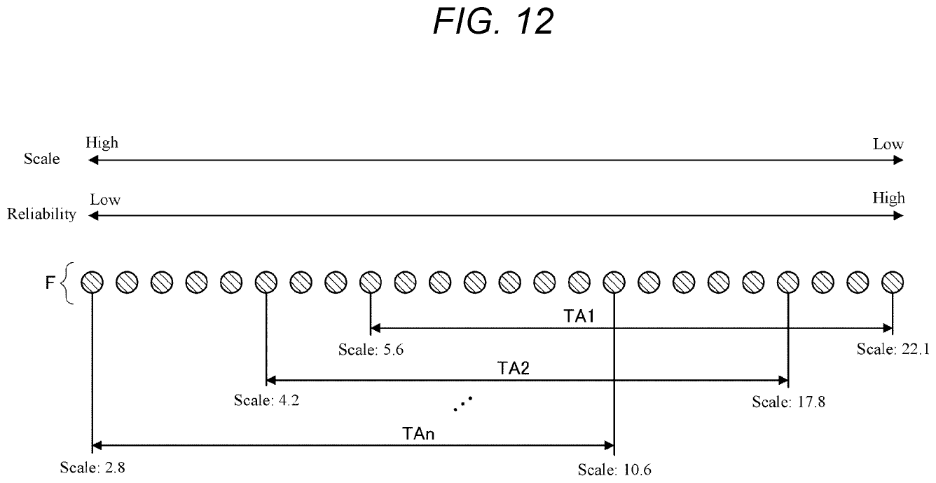

Hereinafter, an example of the method of selecting data to be processed by the selection unit 235 will be described with reference to FIGS. 12 to 16.

### 3-1. First Selection Method

For example, the selection unit 235 according to the present embodiment may use, as the reliability information, resolution information indicating the resolution of the image D from which each of the feature points F is extracted.

FIG. 12 is a diagram for explaining a first method of selecting the processing target by the selection unit 235 according to the present embodiment.

A feature point F illustrated in FIG. 12 indicates the feature point F output from the matching unit 233. In the example illustrated in FIG. 12, each of the feature points F is ordered by the resolution of the image D from which the feature point F is extracted.

A bidirectional arrow Scale in the uppermost part in FIG. 12 indicates a level of the resolution of each feature point F. In addition, a bidirectional arrow Reliability in the middle part of FIG. 12 indicates a level of the reliability of the feature point F.

In the example illustrated in FIG. 12, the feature point F positioned on the right side in FIG. 12 has lower resolution (Low) and higher reliability (High). On the other hand, the feature point F positioned on the left side of FIG. 12 has higher resolution (High) and lower reliability (Low).

As described above, according to the first selection method, the selection unit 235 considers that the lower the resolution of the image D from which each of the feature points F is extracted, the higher the reliability of the feature point F extracted from the image D.

Furthermore, a processing target TAn in FIG. 12 indicates a feature point F selected by the selection unit 235 as data to be processed in each execution time of the correction processing by the optimization unit 237, and n represents the number of times of execution of the correction processing.

For example, the processing target TA1 indicates the feature point F selected as the processing target in the first execution of the correction processing by the optimization unit 237. Furthermore, a processing target TA2 indicates the feature point F selected as the processing target in the second execution of the correction processing by the optimization unit 237.

Furthermore, “Scale: xx.x” indicated at both ends of the bidirectional arrow indicating each processing target TA represents a threshold of the resolution of the image D as an extraction source of the feature point included in the data to be processed in each processing target TA by a ratio of the resolution after conversion to the resolution of the original image D.

For example, “Scale: 22.1” indicated at the right end of the processing target TA1 represents the resolution that is 1/22.1 of the resolution of the original image D.

In the detection of the feature point using the SIFT feature or the like, conversion to a plurality of resolutions is performed on one input image D, and feature points are detected from the converted image D having the plurality of resolutions.

A feature point detected from the image D having a lower resolution has higher noise resistance than a feature point detected from the image D having a higher resolution. Thus, a feature point corresponding to the feature point detected from the image D having the lower resolution is more easily detected among the plurality of images D. Therefore, the feature point detected from the image D having the lower resolution contributes to robustness in the SEM technology.

In addition, the feature point detected from the image D having the higher resolution enable finer analysis on the image, and contributes to higher accuracy of the estimated position of the camera position C.

In view of the above, as illustrated in FIG. 12, the selection unit 235 according to the present embodiment selects the feature point F detected from the image D having a lower resolution as a target of the first execution of the correction processing.

With this arrangement, at the initial stage of the correction processing, the two-dimensional position information of the feature point F, the three-dimensional position information of the three-dimensional point P corresponding to the feature point F, and the position information of the camera position C based on the feature point F having higher noise resistance are obtained. Accordingly, robustness of the process of estimating the three-dimensional structure by the information processing device 20 may be ensured.

Furthermore, as illustrated in FIG. 12, the selection unit 235 according to the present embodiment selects the feature point F detected from the image D having a higher resolution as a processing target at later execution times of the correction processing.

With this arrangement, the three-dimensional structure is estimated with higher accuracy while ensuring the robustness of the process of estimating the three-dimensional structure by the information processing device 20.

### 3-2. Second Selection Method

As another example of the method of selecting the processing target by the selection unit 235 according to the present embodiment, the selection unit 235 may use, as the reliability information, positional accuracy information indicating accuracy of the imaging position of the image D before correction.

For example, in a case where the imaging device 10 is implemented by a drone, it is considered that the imaging device 10 generally includes a position measurement unit for flight. In this case, the information processing device 20 may use the position information of the imaging device 10 obtained by the position measurement unit of the imaging device 10 as the imaging position information of the image D.

The position information obtained by the position measurement unit of the imaging device 10 may be, for example, position information measured by receiving a GNSS signal. Alternatively, as the position information that may be obtained by the imaging device 10, position information based on real time kinematic (RTK) GNSS, post-processing kinematic (PPK) GNSS, or the like, which has accuracy higher than that of the position measurement based on the GNSS alone, may be considered.

In a case where the position information as described above is obtained as the position information of the imaging device 10, the information processing device 20 may obtain the positional accuracy information indicating the accuracy of the position information according to a positioning method.

In such a case, the selection unit 235 according to the present embodiment may use the positional accuracy information as the reliability information.

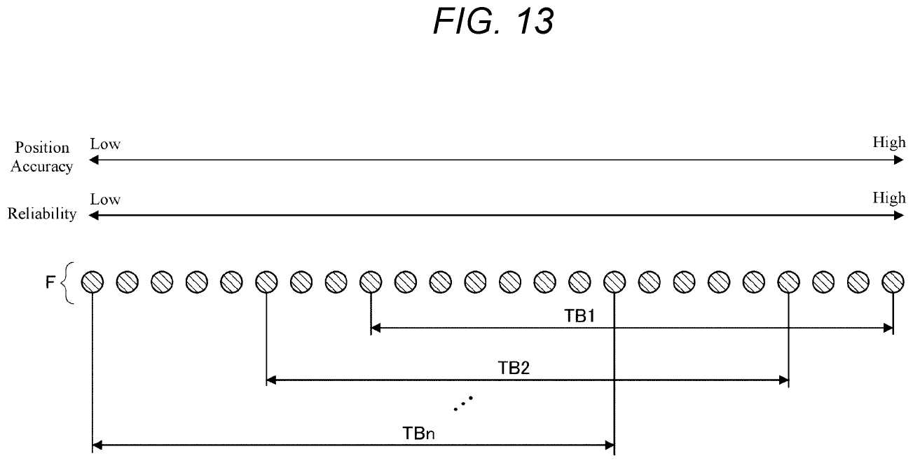

FIG. 13 is a diagram for explaining a second method of selecting the processing target by the selection unit 235 according to the present embodiment. A bidirectional arrow Position Accuracy in the uppermost part in FIG. 13 indicates a positional accuracy level of the position information of the image D from which each of the feature points F is extracted. In addition, a bidirectional arrow Reliability in the second row in FIG. 13 indicates a level of the reliability of each of the feature points F in a similar manner to FIG. 12.

In the example illustrated in FIG. 13, it is understood that the feature point F positioned on the right side in FIG. 13 has higher positional accuracy (High) and higher reliability (High). On the other hand, it is understood that the feature point F positioned on the left side in FIG. 13 has lower positional accuracy (Low) and lower reliability (Low).

As described above, according to the second selection method, the selection unit 235 may consider that the higher the accuracy of the imaging position information before correction indicated by the positional accuracy information of the image D, the higher the reliability of each of the feature points F extracted from the image D.

Furthermore, a processing target TBn in FIG. 13 indicates a feature point F selected by the selection unit 235 as data to be processed in each execution time of the correction processing by the optimization unit 237, and n represents the number of times of execution of the correction processing.

As illustrated in FIG. 13, the selection unit 235 according to the present embodiment selects, as a processing target, the feature point F detected from the image D having higher positional accuracy from among the feature points F as the execution of the correction processing is closer to the initial stage.

With this arrangement, at the initial stage of the correction processing, the two-dimensional position information of the feature point F, the three-dimensional position information of the three-dimensional point P corresponding to the feature point F, and the position information of the camera position C may be obtained on the basis of the feature point F extracted from the image D having the imaging position information with higher accuracy obtained by the imaging device 10 in advance.

Therefore, the three-dimensional position information may be estimated with higher accuracy at the initial stage of the correction processing performed by the optimization unit 237.

Furthermore, as illustrated in FIG. 13, the selection unit 235 according to the present embodiment selects, as a processing target, the feature point F detected from the image D having lower positional accuracy at later execution times of the correction processing.

With this arrangement, the correction processing may also be performed on the feature points F in the range not covered by the correction processing at the initial stage.

### 3-3. Third Selection Method

As another example of the method of selecting the processing target by the selection unit 235 according to the present embodiment, the selection unit 235 may use, as the reliability information, attribute information associated with each of the feature points.

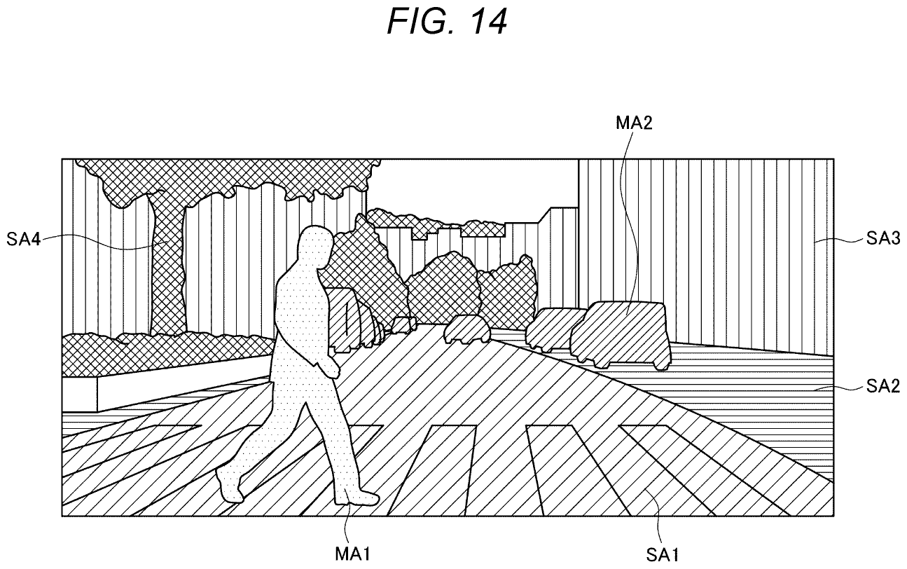

FIG. 14 is an explanatory diagram illustrating an example of the attribute information associated with the feature point F according to the present embodiment.

FIG. 14 illustrates an exemplary case where attribute information of a stationary body area SA indicating a stationary body area or a moving body area MA indicating a moving body area is assigned to a subject in an image area of the image D.

For example, a moving body area MAI illustrated in FIG. 14 indicates an image area on image D in which a pedestrian crossing a pedestrian crossing is present. In addition, a stationary body area SAI indicates an image area on the image D in which a road is present.

According to the SfM technology, a three-dimensional structure is commonly estimated on the assumption that the subject included in the image D is stationary. Thus, when a moving body is included in the image D, the accuracy in estimating the three-dimensional structure decreases.

In view of the above, as illustrated in FIG. 14, in a case where the attribute information indicating the estimation result as to whether or not the area in the image D is a stationary body area is assigned to the image D obtained from the imaging device 10, the information processing device 20 may use the attribute information as the reliability information of the feature point F extracted from the image D.

The attribute information may be assigned to the image D by image analysis performed on the image D in advance. Alternatively, the processing unit 230 of the information processing device 20 may perform the image analysis on the image D obtained from the imaging device 10, and may assign the attribute information to the image D.

Furthermore, the attribute information may be binary label information indicating whether the image area is a stationary body area or a moving body area. Alternatively, the attribute information may be an estimation result indicating the likelihood that the image area has been estimated to be a stationary body area.

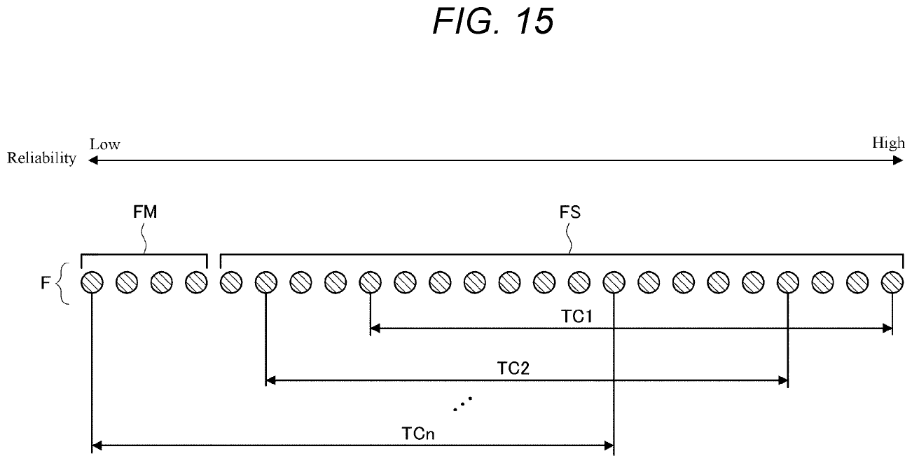

FIG. 15 is a diagram for explaining a third method of selecting the processing target by the selection unit 235 according to the present embodiment. A feature point FS illustrated in FIG. 15 indicates a feature point F extracted from an image area in the image D to which the attribute information indicating a stationary body area is assigned.

Furthermore, a feature point FM illustrated in FIG. indicates a feature point F extracted from an image area in the image D to which the attribute information indicating a moving body area is assigned.

In a similar manner to FIG. 12, a bidirectional arrow Reliability in the uppermost part in FIG. 15 indicates a level of the reliability of the feature point F.

Furthermore, a processing target TCn in FIG. 15 indicates a feature point F selected by the selection unit 235 as data to be processed in each execution time of the correction processing by the optimization unit 237, and n represents the number of times of execution of the correction processing.

As illustrated in FIG. 15, in the present selection method, the selection unit 235 considers that each of the feature points FS to which the attribute information corresponding to the stationary body area is assigned is highly reliable. In addition, each of the feature points FM to which the attribute information corresponding to the moving body area is assigned is considered to be less reliable.

Furthermore, as illustrated in FIG. 15, in the present selection method, the selection unit 235 according to the present embodiment selects the data to be processed at each time such that the feature point to which the attribute information corresponding to the stationary body is assigned is included in the processing target in the first execution of the correction processing.

With this arrangement, at the initial stage of the correction processing, the two-dimensional position information of the feature point F, the three-dimensional position information of the three-dimensional point P corresponding to the feature point F, and the position information of the camera position C corrected on the basis of the feature point F having higher reliability are obtained. Thus, the three-dimensional structure may be estimated with higher accuracy from the initial stage of the correction processing.

### 3-4. Fourth Selection Method

As another example of the method of selecting the processing target by the selection unit 235 according to the present embodiment, the selection unit 235 may use, as the reliability information, a score indicating the reliability of the depth information corresponding to the feature point F obtained by a sensor.

A case is conceivable in which the depth information, which indicates a distance between the imaging device 10 and a ranging point, is assigned by the range sensor or the like to an image area in the image D obtained by the imaging device 10. In this case, the information processing device 20 may use the three-dimensional position information indicated by the depth information in the estimation of the three-dimensional structure based on the SEM technology.

A sensor capable of obtaining the depth information, such as a range sensor, commonly has a noise model that estimates whether or not the depth information obtained by the sensor corresponds to noise. Therefore, the range sensor is enabled to assign a score indicating the reliability of the obtained depth information to the depth information.

In the present selection method, it is assumed that the depth information obtained by the range sensor and the score of the depth information are associated in advance with some or all of the feature points F extracted from each of the images D captured by the imaging device 10.

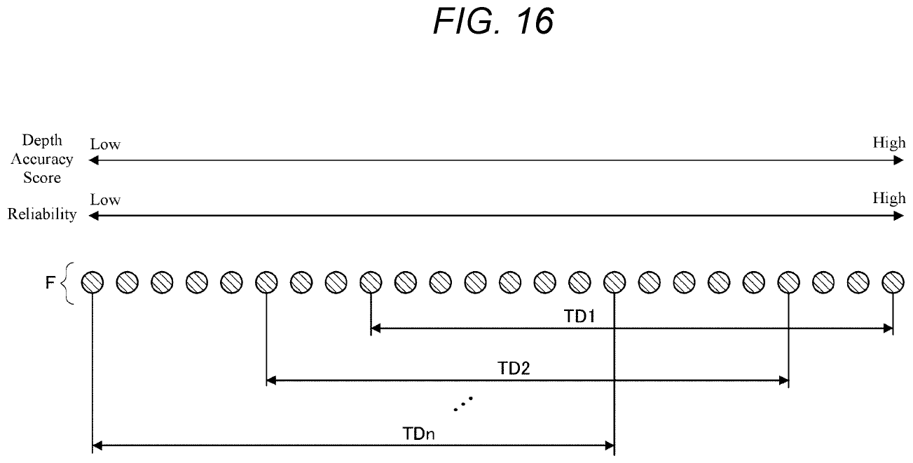

FIG. 16 is a diagram for explaining a fourth method of selecting the processing target by the selection unit 235 according to the present embodiment.

In the example illustrated in FIG. 16, it is assumed that the depth information is associated with all the feature points F.

A bidirectional arrow Depth Accuracy Score in the uppermost part in FIG. 16 indicates a level of the score of the depth information corresponding to each of the feature points F. In the example illustrated in FIG. 16, it is assumed that the reliability of the depth information is higher as the score is higher.

In addition, a bidirectional arrow Reliability in the second row in FIG. 16 indicates a level of the reliability of the feature point F.

As illustrated in FIG. 16, in the present selection method, the selection unit 235 considers that the higher (High) the score of the depth information associated with the feature point F, the higher (High) the reliability of the feature point F to which the score is assigned.

Furthermore, a processing target TDn in FIG. 16 indicates a feature point F selected by the selection unit 235 as data to be processed in each execution time of the correction processing by the optimization unit 237, and n represents the number of times of execution of the correction processing.

As illustrated in FIG. 16, in the present selection method, the selection unit 235 according to the present embodiment selects the data to be processed at each time such that the feature point F associated with the depth information having a higher score is included in the processing target of the correction processing as it is earlier stage of the correction processing.

With this arrangement, at the initial stage of the correction processing, the two-dimensional position information of the feature point F, the three-dimensional position information of the three-dimensional point P corresponding to the feature point F, and the position information of the camera position C are obtained on the basis of the feature point F associated with the depth information having higher reliability. Thus, the three-dimensional structure may be estimated with higher accuracy from the initial stage of the correction processing.

### 3-5. Supplement

The methods of selecting the data to be processed in the correction processing by the selection unit 235 according to the present embodiment have been described above with reference to FIGS. 12 to 16. Note that, as a variation of the fourth selection method described above, the selection unit 235 may also select the processing target as follows by using, as the reliability information, a score indicating the reliability of the depth information.

### (First Variation)

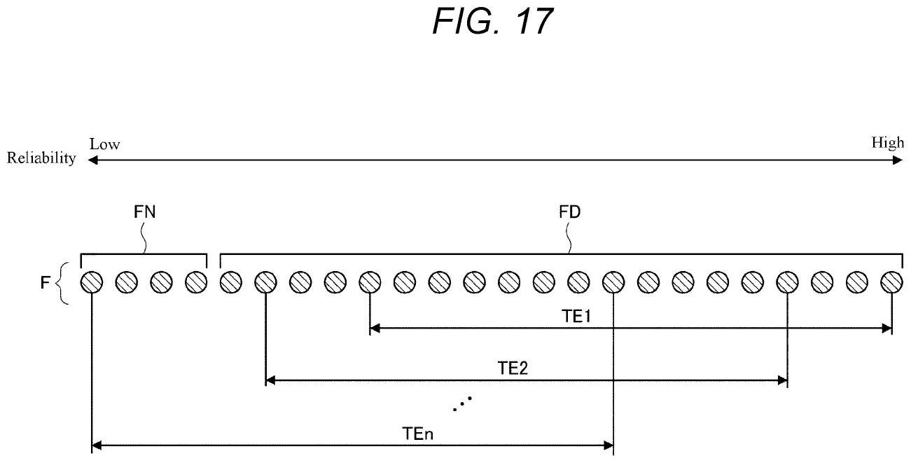

FIG. 17 is a diagram for explaining a variation of the fourth method of selecting the processing target by the selection unit 235 according to the present embodiment.

In the example illustrated in FIG. 17, it is assumed that the depth information is associated with some of the feature points F denoted by feature points FD. In addition, it is assumed that no depth information is associated with the feature points F denoted by feature points FN among the feature points F.

In addition, a bidirectional arrow Reliability in the uppermost part in FIG. 17 indicates a level of the reliability of the feature point F.

As illustrated in FIG. 17, in the present selection method, the selection unit 235 considers that the feature point F associated with the depth information has higher reliability. In addition, the selection unit 235 considers that the feature point F to which no depth information is assigned has lower reliability.

Furthermore, a processing target TEn in FIG. 17 indicates a feature point F selected by the selection unit 235 as data to be processed in each execution time of the correction processing by the optimization unit 237, and n represents the number of times of execution of the correction processing.

As illustrated in FIG. 17, in the present selection method, the selection unit 235 according to the present embodiment selects the data to be processed at each time such that the feature point F associated with the depth information is included in the processing target of the correction processing in the initial stage of the correction processing.

With this arrangement, at the initial stage of the correction processing, the two-dimensional position information of the feature point F, the three-dimensional position information of the three-dimensional point P corresponding to the feature point F, and the position information of the camera position C are obtained on the basis of the feature point F associated with the depth information. Thus, the three-dimensional structure may be estimated with higher accuracy from the initial stage of the correction processing.

### (Second Variation)

Furthermore, in the descriptions above, the exemplary case where the selection unit 235 uses the attribute information associated with the feature point F as the reliability information has been described with reference to FIG. 14. In the example illustrated in FIG. 14, the case where the attribute information indicates a stationary body area or a moving body area on the image D has been described. However, the present disclosure is not limited to such an example.

For example, the selection unit 235 may also use another type of attribute information as the attribute information associated with each of the feature points extracted from the image D. For example, the attribute information may be label information indicating an element that reduces robustness in feature point matching, such as a reflective object including a water surface, glass, or the like.

### (Third Variation)

Furthermore, as a variation of the method of selecting the processing target by the selection unit 235, the selection unit 235 may use, as the reliability information, an image analysis result of the image D from which each of the feature points F is extracted. The image analysis result may include, for example, at least one or more pieces of information of brightness or unsharpness of the image.

With this arrangement, the selection unit 235 is enabled to perform determination such as excluding the image D from the input data used for the correction processing on the basis of, for example, relatively too high or too low brightness of the image D as compared with other images D.

Furthermore, the selection unit 235 may perform determination such as excluding an unclear image from the input data used to estimate the three-dimensional structure on the basis of the image analysis result of the image D.

### (Fourth Variation)

Furthermore, as another variation of the method of selecting the processing target by the selection unit 235, the selection unit 235 may use, as the reliability information, the posture information indicating the imaging posture of the image D from which each of the feature points F is extracted.

For example, in a case where the imaging device 10 is implemented by a flying object such as a drone, if the orientation of the camera 130 indicated by the posture information does not directly face the subject, it is considered highly likely that the obtained image D is not suitable for estimating the three-dimensional structure. In this case, application such as excluding the image D associated with the posture information from the input data of the process of estimating the three-dimensional structure may be made.

Furthermore, it is also possible to detect, using the posture information described above, an abnormality such as shaking of the imaging device 10 due to an external factor such as wind, an earthquake, or the like. In a case where such an abnormality in the imaging posture of the imaging device 10 is detected, it may be considered that there is a factor that lowers the accuracy of the position information of the imaging device 10.

With this arrangement, the information processing device 20 may determine whether or not the camera 130 of the imaging device 10 is being enabled to capture the subject at an angle of view suitable for the process of estimating the three-dimensional structure. Thus, the information processing device 20 may perform the process of estimating the three-dimensional structure with higher accuracy.

### (Fifth Variation)

Furthermore, in the descriptions above, the first to fourth selection methods and the first to fourth variations have been individually described as methods of selecting the processing target by the selection unit 235. However, the selection unit 235 may select the data to be processed in the correction processing by the optimization unit 237 by combining the selection methods described above.

### 4. Exemplary Operation

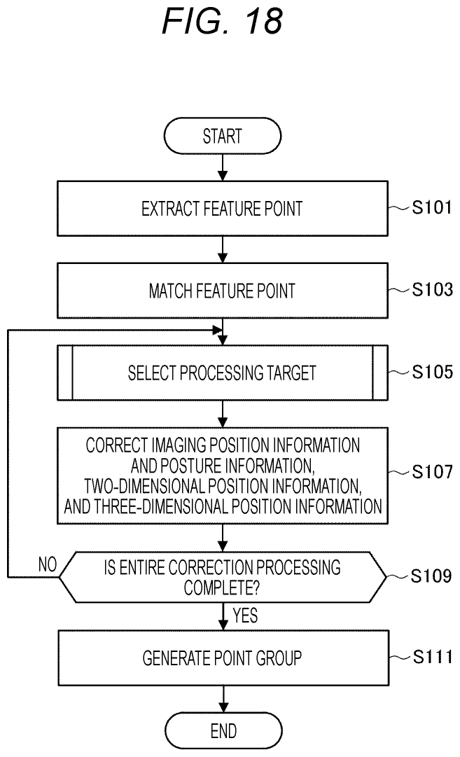

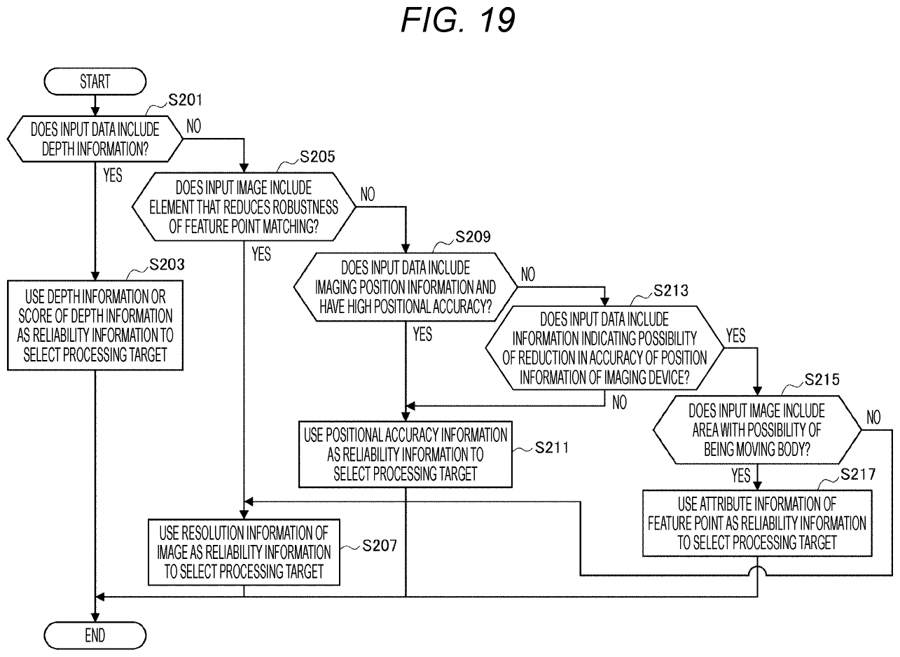

Next, exemplary operation of the information processing system according to the embodiment of the present disclosure will be described with reference to FIGS. 18 and 19.

FIG. 18 is a flowchart for explaining the exemplary operation of the information processing system according to the present embodiment.

A series of processing illustrated in FIG. 18 is started when the information processing device 20 obtains a plurality of images D obtained by imaging the subject, which is a target for restoring the three-dimensional structure, from the imaging device 10.

First, the extraction unit 231 of the information processing device 20 performs processing of extracting feature points from the plurality of images D obtained from the imaging device 10 (S101).

Next, the matching unit 233 performs the matching processing for detecting the corresponding feature points F among the plurality of images D with respect to the feature points F extracted in S101 (S103).

The selection unit 235 selects a processing target at each execution time of the correction processing by the optimization unit 237 from among the corresponding feature points F among the plurality of images D detected by the matching unit 233 (S105).

For the feature point F selected as the processing target at each time by the selection unit 235, the optimization unit 237 performs the correction processing on the imaging position information and posture information of the image D from which the feature point F is extracted, the two-dimensional position information of the feature point F, and the three-dimensional position information of the three-dimensional point P corresponding to the feature point F (S107).

The processing of selecting the data to be processed in one execution time in S105 and the execution of the correction processing on the data selected as the processing target in S105 in S107 are defined as one iteration.

The information processing device 20 according to the present embodiment repeats the iteration described above until the correction processing is completed for the entire feature points F to be corrected among the corresponding feature points F among the plurality of images D detected by the matching unit 233 (NO in S109).

When the iteration described above is repeated and the correction processing is complete for the entire feature points F to be corrected (YES in S109), the generation unit 239 performs processing of generating a three-dimensional point group on the basis of the corrected three-dimensional position information (S111).

The exemplary operation of the information processing system according to the present embodiment has been described with reference to FIG. 18. Next, a processing flow in a subroutine of S105 illustrated in FIG. 18 will be described with reference to FIG. 19.

FIG. 19 is a flowchart for explaining an exemplary flow of the process of selecting the processing target by the selection unit 235 according to the present embodiment. The selection unit 235 may determine the method of selecting the processing target along the flow illustrated in FIG. 19, for example.

In a case where the input data obtained by the information processing device 20 includes the depth information (YES in S201), the selection unit 235 uses the depth information or the score of the depth information as the reliability information to select the processing target (S203).

In a case where the input data obtained by the information processing device 20 does not include the depth information (NO in S201), the process proceeds to S205.

In a case where it is determined that the image D of the input data obtained by the information processing device 20 includes an element that reduces the robustness of the feature point matching (YES in S205), the selection unit 235 uses the resolution information of the image D as the reliability information to select the processing target (S207).

In a case where it is determined that the image D of the input data obtained by the information processing device 20 does not include the element that reduces the robustness of the feature point matching (NO in S205), the process proceeds to S209.

In a case where the input data obtained by the information processing device 20 includes the imaging position information and the positional accuracy of the imaging position information is high (YES in S209), the selection unit 235 uses the positional accuracy information as the reliability information to select the processing target (S211).

In a case where the input data obtained by the information processing device 20 does not include the imaging position information or the positional accuracy of the imaging position information is high (NO in S209), the process proceeds to S213.

In a case where the input data obtained by the information processing device 20 does not include the information indicating the possibility of reduction in the accuracy of the position information of the imaging device (NO in S213), the process proceeds to S211.

In a case where the input data obtained by the information processing device 20 includes the information indicating the possibility of reduction in the accuracy of the position information of the imaging device (YES in S213), the process proceeds to S215.

In a case where the image D obtained as the input data by the information processing device 20 includes an area having a possibility of being a moving body (YES in S215), the selection unit 235 uses the attribute information of the feature point as the reliability information to select the processing target (S217).

In a case where the image D obtained as the input data by the information processing device 20 does not include the area having a possibility of being a moving body (NO in S215), the process proceeds to S207.

The exemplary flow of the process of selecting the processing target by the selection unit 235 according to the present embodiment has been described with reference to FIG. 19.

### 5. Exemplary Hardware Configuration

The embodiments of the present disclosure have been described above. Next, an exemplary hardware configuration common to the imaging device 10 and the information processing device 20 according to the embodiment of the present disclosure will be described.

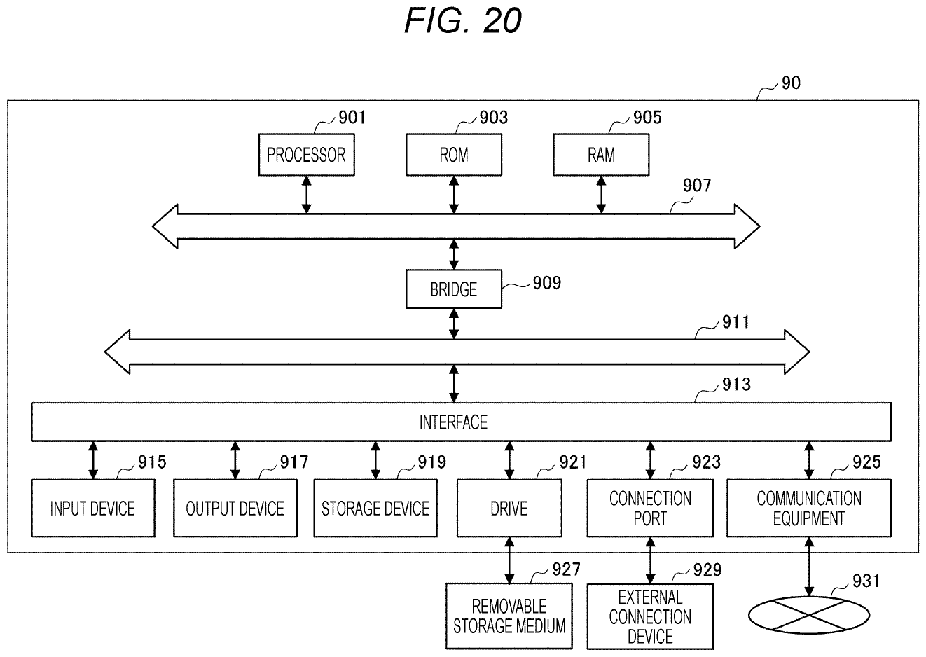

FIG. 20 is a block diagram illustrating a hardware configuration 90 according to the embodiment of the present disclosure.

The hardware configuration 90 may be applied to the imaging device 10 and the information processing device 20.

As illustrated in FIG. 20, the hardware configuration 90 includes, for example, a processor 901, a read only memory (ROM) 903, a random access memory (RAM) 905, a host bus 907, a bridge 909, an external bus 911, an interface 913, an input device 915, an output device 917, a storage device 919, a drive 921, a connection port 923, and communication equipment 925. Note that the hardware configuration illustrated here is merely an example, and some of the components may be omitted. Furthermore, components other than those illustrated here may be further included.

### (Processor 901)

The processor 901 functions as, for example, an arithmetic processing device and a control device, and controls all of or a part of the operation of each component on the basis of various programs recorded in the ROM 903, the RAM 905, the storage device 919, or a removable recording medium 927.

### (ROM 903 and RAM 905)

The ROM 903 is a means for storing a program to be read by the processor 901, data to be used for calculation, or/and the like. The RAM 905 temporarily or permanently stores, for example, a program to be read by the processor 901, various parameters that appropriately change when the program is executed, or/and the like.

### (Host Bus 907, Bridge 909, External Bus 911, and Interface 913)

The processor 901, the ROM 903, and the RAM 905 are mutually connected via, for example, the host bus 907 capable of high-speed data transmission. Meanwhile, the host bus 907 is connected to, for example, the external bus 911 having a relatively low data transmission speed via the bridge 909. Furthermore, the external bus 911 is connected to various components via the interface 913.

### (Input Device 915)

As the input device 915, for example, a mouse, a keyboard, a touch panel, a button, a switch, a lever, and the like are used. Moreover, as the input device 915, a remote controller (hereinafter referred to as a remote) capable of transmitting a control signal using infrared rays or other radio waves may be used. Furthermore, the input device 915 includes a voice input device such as a microphone.

Furthermore, the input device 915 may include an imaging device and a sensor. The imaging device is, for example, a device that generates a captured image by imaging a real space using various members such as an imaging element including a charge coupled device (CCD) or a complementary metal oxide semiconductor (CMOS), a lens for controlling image formation of a subject image on the imaging element, and the like. The imaging device may capture a still image, or may capture a moving image.

Examples of the sensor include various types of sensors, such as a range sensor, an accelerometer, a gyro sensor, a geomagnetic sensor, a vibration sensor, a light sensor, a sound sensor, and the like. The sensor obtains information regarding a state of the hardware configuration 90 itself, such as the orientation of the housing of the hardware configuration 90, or information regarding the surrounding environment of the hardware configuration 90, such as brightness or noise around the hardware configuration 90. Furthermore, the sensor may include a GNSS sensor that receives a GNSS signal to measure the latitude, longitude, and altitude of the device.

### (Output Device 917)

The output device 917 includes a vibration device capable of visually or auditorily notifying the user of obtained information, such as a display device including a cathode ray tube (CRT), a liquid crystal display (LCD), an organic electro-luminescence (EL) display, or the like, an audio output device including a speaker, a headphone, or the like, a printer, a mobile phone, a facsimile, or the like.

### (Storage Device 919)

The storage device 919 is a device for storing various types of data. As the storage device 919, for example, a magnetic storage device such as a hard disk drive (HDD), a semiconductor storage device, an optical storage device, a magneto-optical storage device, or the like is used.

### (Drive 921)

The drive 921 is, for example, a device that reads information recorded in the removable recording medium 927 such as a magnetic disk, an optical disk, a magneto-optical disk, a semiconductor memory, or the like, or writes information to the removable recording medium 927.

### (Removable Recording Medium 927)

Examples of the removable recording medium 927 include a digital versatile disc (DVD) medium, a Blu-ray (registered trademark) medium, an HD-DVD medium, various types of semiconductor storage media, and the like. It is needless to say that the removable recording medium 927 may be, for example, an integrated circuit (IC) card equipped with a contactless IC chip, an electronic device, or the like.

### (Connection Port 923)

The connection port 923 is, for example, a port for connecting an external connection device 929, such as a universal serial bus (USB) port, an IEEE1394 port, a small computer system interface (SCSI) port, an RS-232C port, an optical audio terminal, or the like.

### (External Connection Device 929)

Examples of the external connection device 929 include a printer, a portable music player, a digital camera, a digital video camera, an IC recorder, and the like.

### (Communication Equipment 925)

The communication equipment 925 is a communication device for connection to a network, such as a communication card for wired or wireless local area network (LAN), Bluetooth (registered trademark), or wireless USB (WUSB), a router for optical communication, a router for asymmetric digital subscriber line (ADSL), a modem for various types of communication, or the like.

### 6. CONCLUSION

While the preferred embodiments of the present disclosure have been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

For example, the steps in the processing of the operations of the imaging device 10 and the information processing device 20 according to the present embodiment are not necessarily processed in time series in the order described as the explanatory diagrams. For example, each step in the processing of the operations of the imaging device 10 and the information processing device 20 may be processed in an order different from the order described as the explanatory diagrams, or may be processed in parallel.

Furthermore, one or more computer programs for causing hardware such as a processor, a ROM, a RAM, and the like built in the imaging device 10 and the information processing device 20 described above to exhibit the functions of the information processing system according to the present embodiment may be created. Furthermore, a computer-readable storage medium that stores the one or more computer programs is also provided.

Furthermore, the effects described in the present specification are merely exemplary or illustrative, and are not restrictive. In other words, the technology according to the present disclosure may exhibit other effects apparent to those skilled in the art from the description of the present specification, in addition to the effects described above or instead of the effects described above.

Note that the following configurations also fall within the technological scope of the present disclosure.

(1)

An information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

(2)

The information processing device according to (1) described above, in which
in the correction processing, the processing unit corrects imaging position information indicating an imaging position of each of the images and posture information indicating an imaging posture together with the two-dimensional position information and the three-dimensional position information.
   (3)

The information processing device according to (1) or (2) described above, in which
the processing unit selects the data to be processed at each of the execution times of the correction processing on the basis of reliability information indicating reliability of each of the feature points.
   (4)

The information processing device according to (3) described above, in which
the processing unit selects the data to be processed at each of the execution times of the correction processing in such a manner that, among the individual feature points, the feature point in which the reliability is higher is included in the processing target in, among the plurality of execution times of the correction processing, the execution time at an initial stage.
   (5)

The information processing device according to (3) or (4) described above, in which
the processing unit uses resolution information indicating resolution of the image from which each of the feature points is extracted as the reliability information.
   (6)

The information processing device according to (5) described above, in which
the processing unit considers that the reliability of the feature point extracted from the image is higher as the resolution of the image is lower.
   (7)

The information processing device according to any one of (3) to (6) described above, in which
the processing unit is configured to:
use positional accuracy information indicating accuracy of an imaging position of the image before correction as the reliability information, and
consider that the reliability of each of the feature points extracted from the image is higher as accuracy of imaging position information before the correction indicated by the positional accuracy information regarding the image is higher.
   (8)

The information processing device according to any one of (3) to (7) described above, in which
the processing unit uses attribute information associated with each of the feature points as the reliability information.
   (9)

The information processing device according to (8) described above, in which
the attribute information includes information indicating an estimation result of whether a subject of the image corresponding to the feature point is a stationary body, and
the processing unit is configured to:
consider the reliability of each of the feature points to which the attribute information corresponding to the stationary body is assigned is high; and
consider the reliability of each of the feature points to which the attribute information corresponding to a moving body is assigned is low.
   (10)

The information processing device according to (9) described above, in which
in a first execution time of the correction processing, the processing unit selects the data to be processed at each time in such a manner that the feature point to which the attribute information corresponding to the stationary body is assigned is included in the processing target.
   (11)

The information processing device according to any one of (3) to (10) described above, in which
the processing unit is configured to:
use, as the reliability information of the feature point, a score indicating the reliability of depth information corresponding to the feature point obtained by a sensor; and
consider that the reliability of the feature point to which the score is assigned is higher as the score is higher.
   (12)

The information processing device according to any one of (3) to (10) described above, in which
the processing unit is configured to:
consider that, among the individual feature points, the reliability of the feature point to which depth information corresponding to the feature point is assigned is high; and
consider that the reliability of the feature point to which the corresponding depth information is not assigned is low.
   (13)

The information processing device according to any one of (3) to (12) described above, in which
the processing unit uses, as the reliability information, an image analysis result of the image from which each of the feature points is extracted, and
the image analysis result includes at least one or more pieces of information of brightness or unsharpness of the image.
   (14)

The information processing device according to any one of (3) to (13) described above, in which
the processing unit uses posture information indicating an imaging posture of each of the images as the reliability information.
   (15)

The information processing device according to any one of (1) to (14) described above, in which
the processing unit selects the data to be processed at each of the execution times of the correction processing on the basis of one or both of a setting value of the number of pieces of the data to be processed at each of the execution times of the correction processing or a setting value of the total number of times of execution indicating how many times the correction processing is to be executed separately.
   (16)

The information processing device according to any one of (3) to (14) described above, in which
the processing unit selects the data to be processed at each of the execution times of the correction processing by comparing the reliability of each of the feature points with a predetermined threshold.
   (17)

The information processing device according to (15) described above, in which
the processing unit dynamically sets the setting value of the number of pieces of the data to be processed at each of the execution times of the correction processing or the setting value of the total number of times of execution depending on a processing load condition of the information processing device.
   (18)

An information processing method to be executed by a computer,
the method causing a processor to perform:
executing correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.
   (19)

A program that causes a computer to function as an information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on the basis of the plurality of images separately for each piece of data selected as processing target of each time of a plurality of execution times.

### REFERENCE SIGNS LIST

10 Imaging device
110 Communication unit
130 Camera
20 Information processing device
210 Communication unit
230 Processing unit
231 Extraction unit
233 Matching unit
235 Selection unit
237 Optimization unit
239 Generation unit

1. An information processing device comprising a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on a basis of the plurality of images separately for each piece of data selected as processing target of each time of a plurality of execution times.

2. The information processing device according to claim 1, wherein
in the correction processing, the processing unit corrects imaging position information indicating an imaging position of each of the images and posture information indicating an imaging posture together with the two-dimensional position information and the three-dimensional position information.

3. The information processing device according to claim 1, wherein
the processing unit selects the data to be processed at each of the execution times of the correction processing on a basis of reliability information indicating reliability of each of the feature points.

4. The information processing device according to claim 3, wherein
the processing unit selects the data to be processed at each of the execution times of the correction processing in such a manner that, among the individual feature points, the feature point in which the reliability is higher is included in the processing target in, among the plurality of execution times of the correction processing, the execution time at an initial stage.

5. The information processing device according to claim 3, wherein
the processing unit uses resolution information indicating resolution of the image from which each of the feature points is extracted as the reliability information.

6. The information processing device according to claim 5, wherein
the processing unit considers that the reliability of the feature point extracted from the image is higher as the resolution of the image is lower.

7. The information processing device according to claim 3, wherein
the processing unit is configured to:
use positional accuracy information indicating accuracy of an imaging position of the image before correction as the reliability information, and
consider that the reliability of each of the feature points extracted from the image is higher as accuracy of imaging position information before the correction indicated by the positional accuracy information regarding the image is higher.

8. The information processing device according to claim 3, wherein
the processing unit uses attribute information associated with each of the feature points as the reliability information.

9. The information processing device according to claim 8, wherein
the attribute information includes information indicating an estimation result of whether a subject of the image corresponding to the feature point is a stationary body, and
the processing unit is configured to:
consider the reliability of each of the feature points to which the attribute information corresponding to the stationary body is assigned is high; and
consider the reliability of each of the feature points to which the attribute information corresponding to a moving body is assigned is low.

10. The information processing device according to claim 9, wherein
in a first execution time of the correction processing, the processing unit selects the data to be processed at each time in such a manner that the feature point to which the attribute information corresponding to the stationary body is assigned is included in the processing target.

11. The information processing device according to claim 3, wherein
the processing unit is configured to:
use, as the reliability information of the feature point, a score indicating the reliability of depth information corresponding to the feature point obtained by a sensor; and
consider that the reliability of the feature point to which the score is assigned is higher as the score is higher.

12. The information processing device according to claim 3, wherein
the processing unit is configured to:
consider that, among the individual feature points, the reliability of the feature point to which depth information corresponding to the feature point is assigned is high; and
consider that the reliability of the feature point to which the corresponding depth information is not assigned is low.

13. The information processing device according to claim 3, wherein
the processing unit uses, as the reliability information, an image analysis result of the image from which each of the feature points is extracted, and
the image analysis result includes at least one or more pieces of information of brightness or unsharpness of the image.

14. The information processing device according to claim 3, wherein
the processing unit uses posture information indicating an imaging posture of each of the images as the reliability information.

15. The information processing device according to claim 1, wherein
the processing unit selects the data to be processed at each of the execution times of the correction processing on a basis of one or both of a setting value of a number of pieces of the data to be processed at each of the execution times of the correction processing or a setting value of a total number of times of execution indicating how many times the correction processing is to be executed separately.

16. The information processing device according to claim 3, wherein
the processing unit selects the data to be processed at each of the execution times of the correction processing by comparing the reliability of each of the feature points with a predetermined threshold.

17. The information processing device according to claim 15, wherein
the processing unit dynamically sets the setting value of the number of pieces of the data to be processed at each of the execution times of the correction processing or the setting value of the total number of times of execution depending on a processing load condition of the information processing device.

18. An information processing method to be executed by a computer,
the method causing a processor to perform:
executing correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on a basis of the plurality of images separately for each piece of data selected as processing target of each time of a plurality of execution times.

19. A program that causes a computer to function as an information processing device including a processing unit that executes correction processing that corrects, for each of feature points of a plurality of images extracted from the plurality of images obtained by imaging a predetermined space, two-dimensional position information indicating a position of each of the feature points on the image and three-dimensional position information of a point corresponding to each of the feature points on a three-dimensional point group that represents the predetermined space as a point group on a basis of the plurality of images separately for each piece of data selected as processing target of each time of a plurality of execution times.
